(19) United States
(12) Patent Application Publication
(10) Pub. No.: US 2014/0143750 A1
(43) Pub. Date: May 22, 2014

(54) Structured Enterprise Software Knowledgebase Utilities, And Methods Of Use Thereof

(71) Applicant: Rajesh Gangadharan, Coppell, TX (US)

(72) Inventor: Rajesh Gangadharan, Coppell, TX (US)

(73) Assignee: ECOGNIZ INC, Coppell, TX (US)

(21) Appl. No.: 13/684,228

(22) Filed: Nov. 22, 2012

(51) Int. Cl. G06F 9/44

(52) U.S. Cl. CPC G06F 8/10
USPC 717/102

(57) ABSTRACT

An enterprise application software knowledgebase (EASK) system is provided for documenting solution designs of enterprise software in a structured manner to reduce the time and costs of implementing and maintaining a solution. In one embodiment, an EASK utility receives, from a user in an organization, information about business processes to be implemented by the organization. The EASK utility generates, from the information about the business processes, a list of functional requirements for the organization. The utility identifies, from an application knowledgebase, configurations settings that match with the functional requirements. A project knowledgebase is created for the enterprise software solution design of the organization. The utility may store the functional requirements and the configuration settings in the project knowledgebase.

### TECHNICAL FIELD

The illustrative embodiments relate generally to implementing enterprise application software solutions in data processing systems, and more particularly, to providing an enterprise application software knowledgebase system for documenting solution designs of enterprise software in a structured manner to, inter alia, reduce the time and costs of implementing or maintaining a solution.

### BACKGROUND

Driven by the Y2K issue, enterprise application software has gained increasing popularity and acceptance in companies of all sizes across the world. Today, most large and mid-size companies use enterprise application software from software vendors such as Oracle and SAP to enable their business processes. Enterprise application software vendors typically provide software solutions for business functions such as finance, accounting, manufacturing, operations, supply chain, sales, service, etc. Many companies have transitioned from their legacy (old mainframe based home grown) systems to these enterprise application software providers. Enterprise software applications may be implemented within a company's premises or as a cloud application wherein the application is implemented at a location managed by the software provider and the application is accessed over the Internet.

A key difference between enterprise application software of today and the legacy systems of earlier years is that while the legacy systems were custom built (i.e., software built from scratch using programming languages and database tools) to enable a company's business process, the enterprise application software is pre-built by software providers based on certain standardized business processes (software providers may claim that these are best practice business processes). Enterprise application software is often organized based on modules which align with business processes—modules for finance, procurement, sales operations, supply chain planning, customer relationship management are commonly aligned with financial, procurement, manufacturing, planning and sales/service processes of a business. The standardization of processes across industries has increased the adoption of enterprise application software. Since business processes can vary significantly by industry, region of the world, and company size, enterprise application software vendors usually release modules with several technical settings which let companies select options in the software that best meet their needs; this may be in the form of a list of “menu” offerings from which the companies can pick and choose. With large software vendors such as Oracle and SAP, there is often a multitude of menu offerings for each module since the providers have to cater to customers across a wide spectrum of industries and regions. Once a company purchases the software and decides to use it, the job of selecting the options to use in the software and configuring those options falls into the hands of a specialist implementation consulting team that has experts who have implemented the software at other companies in the industry and know the various settings available in the software, and which ones are the best options to use.

The group of activities involved in setting up the software for use by a company is called a software “implementation”. Companies may take different approaches to implementations—they might implement one module or multiple modules at a time, or they might implement at a geographic region or across different regions. At the end of each implementation the software is ready for use (may be called a Go-live event) for that particular business unit/region, etc. Prior to Go-live, users are trained on how to use the system, a support team is in place to maintain and support the software and the new processes in place that use the software. After Go-live, the new processes become operational with the new software—users start performing their tasks using the new system.

The selection from the “menu of options” which is available in the software can be broadly called configurations—these may include global settings, field settings, selections, object parameters, profiles, data fields, custom objects, interface configurations, reports, user exits, profiles, tables, macros, etc. Setting up configurations may require turning on switches, setting up objects such as profiles, setting up macros or user exits which include logic programmed through coding languages that are part of enterprise software such as ABAP for SAP. These configurations or “configuration settings” enable certain business process features and functions. These business process features and functions that are enabled by enterprise application software are broadly referred to as “functional requirements”—i.e., requirements that are functional in the software. Functional requirements may include business policies, processes, procedures, business functions, business rules, parameters, master data relationships, reporting needs, analysis capabilities, etc. Together, the functional requirements and system configurations may constitute the software design, also referred to by some as the solution blueprint.

Existing techniques for documenting enterprise application projects capture the knowledge of functional requirements and configurations settings in an unstructured format, typically in Microsoft® office documents such as Word® or Excel®, among others. Often during each implementation, companies capture this knowledge in hundreds of Microsoft® office documents. Thus, information about an implementation may be stored in multiple disparate files, which can make maintaining and supporting the enterprise application product in an efficient and economical manner more difficult. A need therefore exists in which requirements and configurations about an implementation of an enterprise application solution may be captured and documented in a structured form into a single knowledgebase to reduce the time and cost of solution design and maintenance.

### SUMMARY

According to an illustrative embodiment, a method in a data processing system is provided for creating a design for an enterprise software solution. A data processing system comprising an enterprise application software knowledgebase (EASK) utility receives, from a user in an organization, information about business processes of the organization. The EASK utility generates, from the information about the organization and its business processes, a list of functional requirements for the organization. The utility identifies, from an application knowledgebase, configurations settings that enable the functional requirements. A project knowledgebase is created, capturing the enterprise software solution design of the organization. The utility may store the functional requirements and the configuration settings in the project knowledgebase.

According to another illustrative embodiment, a method in a data processing system is provided for documenting a design of an enterprise software solution. The EASK utility obtains configuration settings for an implemented solution. The utility may identify, from an application knowledgebase, functional requirements linked to (enabled by) the configuration settings. A project knowledgebase may be created for documenting the enterprise software solution for the organization from the application knowledgebase. The utility may store the configuration settings and the linked functional requirements in the project knowledgebase.

According to another illustrative embodiment, a method in a data processing system is provided for documenting a design of an enterprise software solution. The EASK utility obtains functional requirements for an implemented solution. The utility may identify, from an application knowledgebase, configuration settings that enable the functional requirements. A project knowledgebase may be created for documenting the enterprise software solution for the organization from the application knowledgebase. The utility may store the functional requirements and the enabling configuration settings in the project knowledgebase.

According to another illustrative embodiment, a method in a data processing system is provided for determining points of impact for a change in an enterprise software solution. The EASK utility receives, from a user, a set of search criteria for one of a functional requirement or a configuration setting in an enterprise software. The utility may provide, from a project knowledgebase, a list of functional requirements or configuration settings matching the set of search criteria to the user. Responsive to receiving a selection by the user of a functional requirement or configuration setting in the list, the utility provides, from the project knowledgebase, a list to the user of all areas in the enterprise software impacted by a change to the selected functional requirement or configuration setting.

### BRIEF DESCRIPTION OF THE DRAWINGS

FIG. 1 is a schematic, pictorial representation of an enterprise application adoption lifecycle according to an illustrative embodiment;

FIG. 2 is a diagram of an enterprise application software knowledgebase (EASK) utility according to an illustrative embodiment;

FIG. 3 is a diagram illustrating the creation of an application knowledgebase according to an illustrative embodiment;

FIG. 4 is a diagram illustrating requirements gathering and design creation for an enterprise application software implementation according to an illustrative embodiment;

FIG. 5 is a diagram further illustrating design documentation using an application knowledgebase according to an illustrative embodiment;

FIG. 6 is a diagram further illustrating design documentation without an application knowledgebase according to an illustrative embodiment;

FIG. 7 is a diagram illustrating ways a user may access and update a project knowledgebase according to an illustrative embodiment;

FIG. 8 is a diagram illustrating an example training utility for enterprise software providers or consulting service providers according to an illustrative embodiment;

FIG. 9 is a diagram illustrating example objects within the EASK utility according to an illustrative embodiment;

FIG. 10 is a flowchart of a process in the EASK utility for gathering requirements and creating a solution design for a new enterprise software implementation using a Q&A tool according to an illustrative embodiment;

FIG. 11 is a flowchart of a process in the EASK utility for gathering requirements and creating a solution design for a new enterprise software implementation using a search/select tool according to an illustrative embodiment;

FIG. 12 is a flowchart of a process for creating a project knowledgebase by capturing current enterprise software configurations according to an illustrative embodiment;

FIG. 13 is a flowchart of a process for using a knowledgebase to find functional requirements and configuration settings about an implemented enterprise solution according to an illustrative embodiment;

FIG. 14 is a flowchart of a process for creating new knowledgebases or updating existing knowledgebases according to an illustrative embodiment; and

FIG. 15 is a block diagram of a computing device with which the illustrative embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

As stated previously, business processes at most corporations across the world are powered by enterprise application software. The main providers of enterprise software include SAP and Oracle. As enterprise software is complex, setup or implementation of the software at a company or organization requires software experts or knowledgeable consultants who have implemented the software at multiple sites. Based on their experience, these experts know how to design a company's processes to best meet the needs of the company, while at the same time leveraging the software's capabilities to its best advantage. In addition, these experts usually have an in-depth understanding of the software's capabilities and know which configuration settings are required to enable a particular functionality.

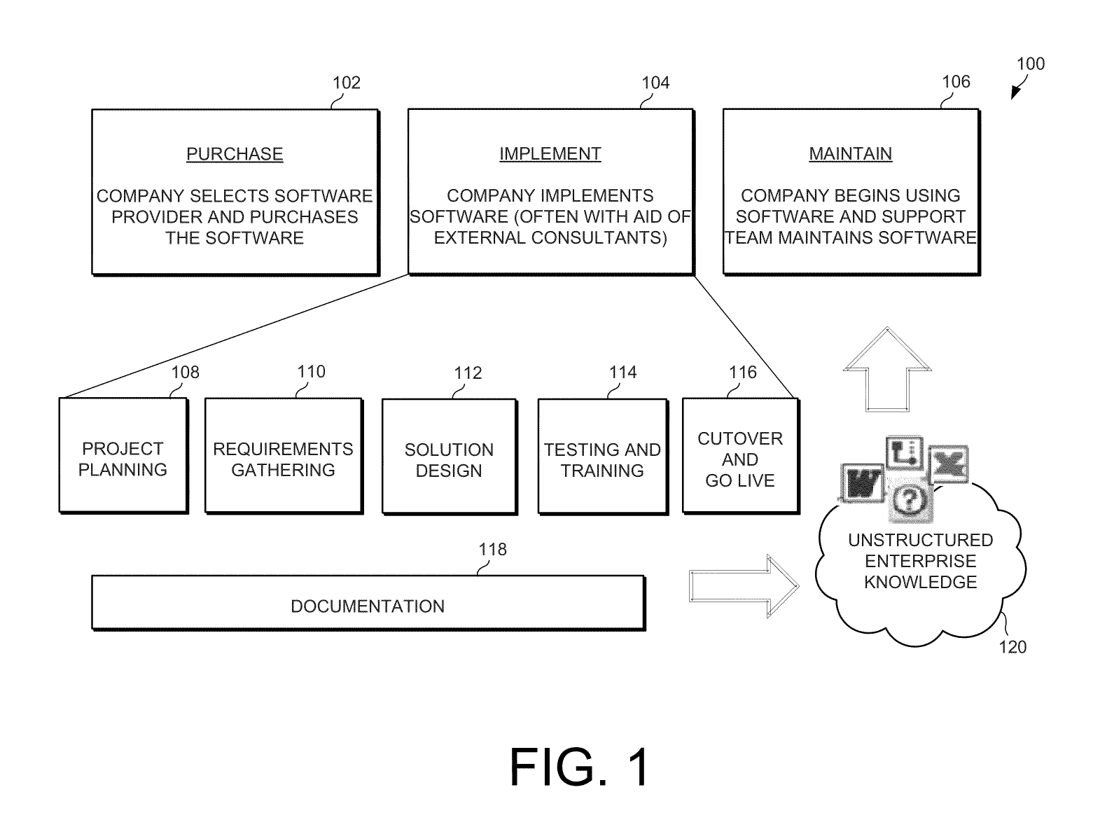

Turning now to the figures, FIG. 1 is a schematic, pictorial representation of an enterprise application adoption lifecycle according to an illustrative embodiment. Enterprise application software adoption cycle 100, which may last several years, typically comprises a purchase phase 102, implementation phase 104, and maintenance phase 106. Enterprise application software adoption cycle 100 may begin with the purchase phase 102 in which a company selects the enterprise software that best meets its business needs and budget. Once the company purchases the software, the next step is to “implement” or setup the software for the company to use. Getting the software ready for use at a company often involves changes to business processes, i.e., to the way business is performed by the company. These changes may involve changes to the company's business processes and also to the day-to-day work for many users who will use the new software for at least some of their duties. Implementation phases can run for months or years depending on the scale of the implementation and how many business units/geographic regions and business process areas are involved.

The implementation phase 104 may often be broken down into the following sub-phases: (1) project planning 108, (2) requirements gathering 110, (3) solution design 112, (4) testing and training 114, and (5) cutover and go-live 116. The project planning phase 108 involves preparation activities of administrative nature such as defining project scope, timelines, setting up the project teams, bringing onboard resources, etc. The requirements gathering phase 110 involves obtaining information about an organization and its business processes. The requirements gathering phase 110 may be broken down further into more phases if desired. The solution design phase 112 may also be referred to as the “blueprinting” phase. One goal of this phase is to prepare a solution design. A solution design may include business process details of the new processes, detailed functional requirements and system configuration details (e.g., fields, tables, technical settings, data maps, etc.) and the linkages/mappings between them. The testing and training phase 114 involves setting up and testing the configuration settings and training users on how to use the system. The cutover and go live phase 116 involves preparation of the system for use by the company's personnel in its business processes and transitioning to the new system. Regardless of how the phases are broken down, activities performed in phases 108-116 may be utilized to gain a deep understanding of a company's business functions, and to design processes that best meet the business' needs, as well as take full advantage of the software capabilities. In contrast with custom software development in which requirements gathering is not affected or influenced by the software capabilities, in enterprise software implementations, software capabilities can play a big role in designing the processes and defining a company's requirements. Experts often refer to best practice processes which are processes they have identified as a best practice by industry and process area, and which they would recommend for a new enterprise software implementation as a starting point.

During the implementation phase 104, a tremendous amount of knowledge may be generated in the form of new business processes, detailed functional requirements, new business policies and procedures, software system configuration settings, etc. In current implementation techniques, implementation teams typically capture and document this knowledge using Microsoft Office documents, such as Word, Excel, and Visio documents, among others. In many cases, several hundred documents may be created by a team to capture this knowledge. However, a problem with these existing techniques is that these Microsoft Office documents store data in unstructured format which make knowledge within the documentation hard to find and maintain.

Once the implementation stage 104 is complete and the enterprise software is being used by the company, the lifecycle 100 enters a maintenance phase 106. The maintenance phase 106 is one in which a support team maintains the enterprise software implemented at the company. The problems inherent with existing techniques become evident when support personnel look through the stored documentation 118 for information needed to resolve an issue with the enterprise software. As this documented information is stored in an unstructured format 120 and often comprises several hundreds of separate, distinct design documents, the support personnel may have to scan through all of these documents to find the needed information, which can be a lengthy and costly process, negatively impacting the response time and cost involved to resolve support issues.

The illustrative embodiments address this issue by providing an enterprise application software knowledgebase (EASK) utility for documenting functional requirements and system configuration settings for new or existing implementations of enterprise software in a structured knowledgebase. A knowledgebase is an information repository that provides a means for information to be collected, organized, shared, searched, and/or utilized. A structured knowledgebase format is one in which functional requirements and configuration settings for a company are captured as individual objects structured using a taxonomy/schema in the knowledgebase. With each detailed functional requirement and configuration setting captured as an object, it is possible to add more details for the object such as type of requirement or areas where the requirement is applicable (e.g., a particular requirement is only applicable to U.S. customers and not international customers). Each requirement and configuration object may have tags and links which can carry various attributes that can later be used for search and analysis. For example, the captured requirements may be organized in a hierarchical manner, and the configurations may be linked together based on a taxonomy. Each requirement may be linked to one or more configurations, and vice versa.

A configuration is a system setting in the software that enables a requirement. A configuration may include, for example, global settings, fields, profiles, data fields, custom objects, system parameters, report settings, user exits, profiles, tables, macros, interface settings, etc. Setting up configurations may comprise turning on switches, setting up objects such as profiles, setting up macros or user exits which include logic programmed through coding languages that are part of enterprise software such as ABAP for SAP, among others. These configurations or “configuration settings” enable certain business needs, such as, for example, business processes, policies, procedures, etc.

A requirement is a capability required to enable a certain business need. A requirement may specify a function that a system or component must be able to perform. A functional requirement is a requirement that is functional in the software—i.e., the requirement is met by the software. Consider an example of an order management system that a sales representative uses to enter customer orders. In this example, a requirement may comprise the ability to input a customer's address on an order entry screen of the order management system used by the sales representative. The requirement states that the software should provide a placeholder for the sales representative to enter a customer's address when entering the customer's order into the order management system. The order management system may have a “Customer Address” object which is a part of the order entry screen. To enable the requirement mentioned above in the order management system, a “Customer Address” configuration object may need to be activated.

Consider another example of a requirement in a company's supply chain business process. The requirement specifies the “Ability to take into account reorder point levels when replenishing stock”. To enable this requirement in the enterprise supply chain software, a configuration setting in the form of a boolean (TRUE/FALSE) field in the enterprise software that states “Replenish to Reorder Point” may be set to “TRUE” to have the system replenish to reorder points. In addition, there may be another configuration setting for “Material Reorder Point” in the enterprise supply chain software which is used to specify the quantity that should be set as the reorder point. Together, these two configuration settings—the boolean switch “Replenish to Reorder Point” and the switch “Material Reorder Point”—are used to enable the “Ability to take into account reorder point levels when replenishing stock” requirement in the software. Thus, the requirements and system configurations together may constitute a part of the enterprise supply chain software solution design.

As the illustrative embodiments of the EASK system employ a structured format for documenting the enterprise software solution design in a knowledgebase, users may quickly and easily locate design details by leveraging the tags and linkages between the objects in the knowledgebase. Use of the EASK utility also reduces implementation costs and timelines by providing a simple mechanism to document system details (e.g., configurations, data fields, etc.) and process details (e.g., requirements, scenarios, etc.) using information in the knowledgebase. The knowledge schema and the structured content in the knowledgebase may act as the basis for the EASK documentation utility. By providing documented information in such a structured format, the illustrative embodiments enable a company to significantly reduce time and costs for implementation of application software in the requirements gathering and design stages. Currently, some implementation stages are a highly manual process which is heavily dependent on outside consultants. By using a structured knowledgebase to capture design documentation as disclosed in the illustrative embodiments, companies can reduce dependence on consultants and significantly speed up the implementation phase.

For new implementations where new enterprise software is being installed at a company, personnel at the company may not know how to use the software or set it up for use. The company may often employ consultants to implement the software for the company and get it ready for use. The consulting company may bring the knowledgebase to the company or the company may purchase the knowledgebase directly. Having the knowledgebase during the implementation speeds up the process of creating a new solution design for a company because design knowledge is already built in to the knowledgebase. A knowledgebase may comprise an application knowledgebase or a project knowledgebase. An application knowledgebase provides detailed requirements and configuration settings to make all of the requirements work for a given business process area. The application knowledgebase is a superset knowledgebase that contains all the configuration settings available within a software module and the enabled functional requirements and their mappings, and all of these requirements and settings are linked together so they are easy to understand and find. A project knowledgebase comprises requirements, configurations and mappings that are relevant to a particular company or a particular project. In one embodiment, a project knowledgebase may be derived from an application knowledgebase. To determine requirements, configurations and mappings that are relevant to a particular company, consultants may ask the company personnel various questions, and based on responses to the questions, the EASK system may determine the requirements, configurations and mappings for the company's project knowledgebase. This process is facilitated through the knowledgebase tool. As customers provide answers, the knowledgebase tool may guide the consultants to ask more detailed questions to gain a better understanding of the company's business. Based on the determined business requirements, the knowledgebase tool may automatically select the configuration settings applicable to those requirements.

For existing implementations where enterprise software is already being used at a company, the EASK utility may be employed as a documentation utility. A company may capture its system design into a project knowledgebase to allow personnel who support and maintain the enterprise software to easily understand and find information about the software design. New support personnel can also be brought up to speed quickly as all design information may reside in a single knowledgebase, rather than in multiple, discrete design documents. Thus, if key support personnel leave the company, the impact is minimized as all of the design information is still retained in the project knowledgebase and others can access the information needed to adequately support the enterprise software.

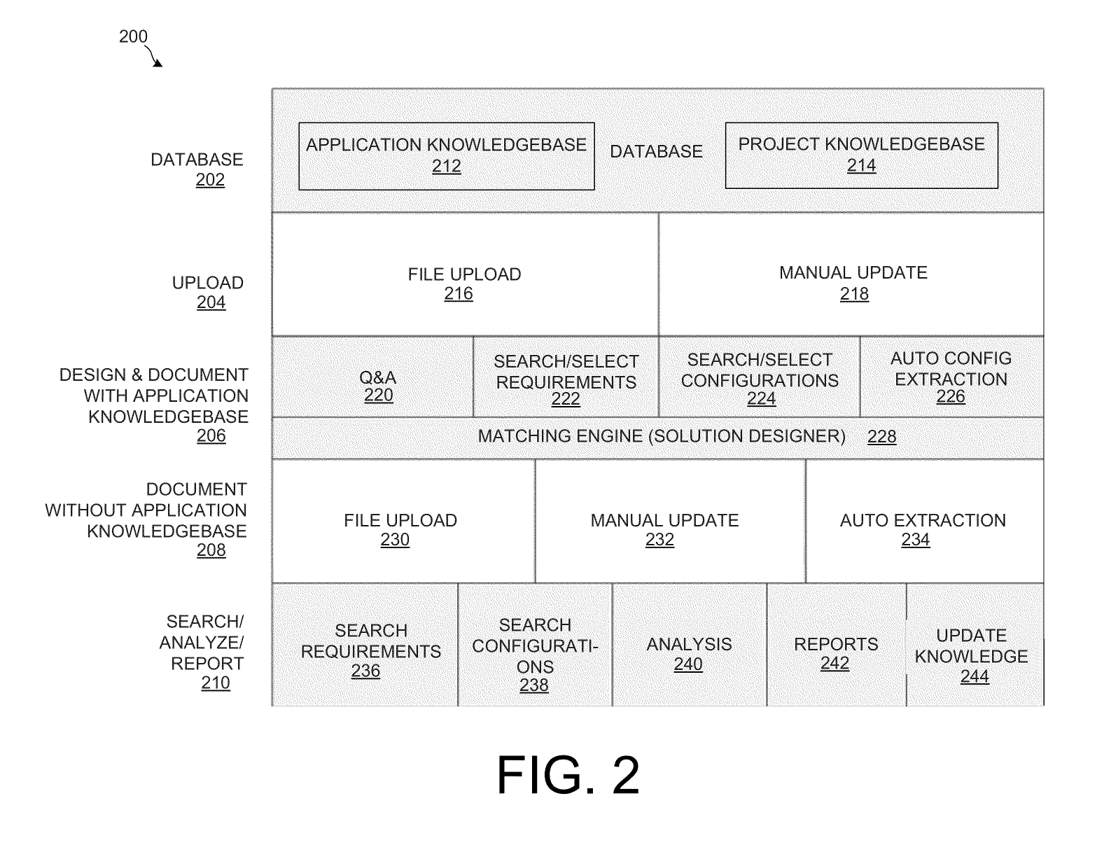

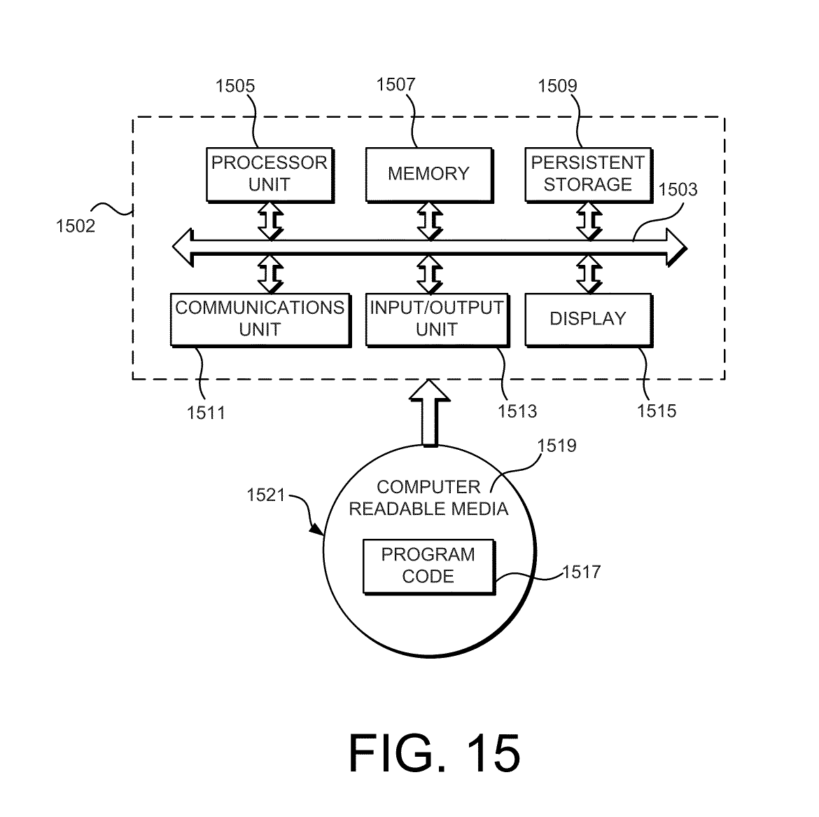

FIG. 2 is a diagram of an EASK utility according to an illustrative embodiment. The EASK utility 200 may be implemented in a data processing system, such as computing device 1502 in FIG. 15. The EASK utility 200 comprises a data processing system that may include a plurality of software components or modules used for documenting solution design in a structured knowledgebase. In the illustrative embodiment, the EASK utility 200 is shown to include various components, including database 202, upload component 204, design & document with application knowledgebase component 206, document without application knowledgebase component 208, and a search/analyze/report component 210. However, it should be noted that the EASK utility 200 is only meant as an example and not intended as a limitation on different illustrative embodiments. For instance, the EASK utility may be implemented as an intranet application, i.e., within a company's firewall or it may be implemented as a Internet cloud application where the utility is installed on servers which can be accessed by users through the Internet. In other words, the EASK utility 200 may include more or fewer components and may be installed as an intranet or cloud application as necessary to accomplish the processes of the different illustrative embodiments.

The database 202 may be a software layer in the EASK utility 200 which is used to capture solution design information into a structured format. This software layer comprises the underlying knowledgebase schema that provides the underlying structure to capture a solution design into the database in a structured format. In addition to functional requirements and configuration settings, the captured knowledge may include linkages between objects that are used to define known relationships between configuration setting objects and requirements objects and tags comprising attributes that may later be used for search and analysis. The database 202 is the foundation structure on which solution design knowledge is added to the system. The database 202 may comprise an application knowledgebase 212 that comprises all functional requirements, configuration settings, linkages, and attributes for a given business process area or industry. The database 202 may also comprise one or more project knowledgebases 214 created by the company who purchased the enterprise software (or consultants) that comprises selected functional requirements, configuration settings, linkages, and attributes for the particular solution design being implemented and used by the company. Thus, the application knowledgebase may comprise all possible functional details of the purchased enterprise software as well as the configuration settings and linkages, and the project knowledgebase may comprise selected functional and technical details that are applicable to a particular implementation of an enterprise software module by a company, including process design details, business policies and rules, functional requirements relevant to the company, and software features that enable the requirements.

Upload component 204 is used to add content (e.g., technical and business knowledge) to a knowledgebase. In one embodiment, this content may be used to create an application knowledgebase that comprises all features and functions within an enterprise software module. For example, an application knowledgebase may be created which includes all features and functions within an SAP procurement module or within an Oracle order fulfillment module. In another embodiment, upload component 204 may be used to create a project knowledgebase that comprises content relevant only for a particular project. In either embodiment, a knowledgebase may be created by one of two modes: through a file upload tool 216 in the EASK utility where a user inputs knowledge into a file (e.g., an Excel file) which then is uploaded to the enterprise software, or through a manual update tool 218 where a user enters the knowledge manually using a data input screen in the EASK utility. Once the knowledge is uploaded or manually updated, a knowledgebase may be created in the database layer 202.

Design & document component 206 may be used to generate a solution design and create project knowledgebases using the application knowledgebase. Design & document component 206 uses the application knowledgebase (created after content is added to the knowledgebase as described above) as a starting point for a company to help them to arrive at a software design.

The design may be created/documented with the use of the application knowledgebase in two modes: starting from the requirements and then obtaining configuration settings, or starting from the configuration settings and then obtaining requirements. In the first mode of starting from the requirements and then obtaining configuration settings, a company may first identify the functional requirements of the company's business and then use these requirements to arrive at a solution design. In one embodiment, requirements information may be gathered using a Q&A tool 220. The Q&A tool 220 may be developed by experts in the enterprise application software. The Q&A tool 220 enables a user to browse through the application knowledgebase via a question and answer interface. The interface walks the user gradually through the levels of detail of the company's business process, and may, in one example, begin from high-level processes down to specific details about these processes to enable the user to identify the functional requirements applicable or relevant to the company. Once the system has provided a list of the relevant requirements to the user based on the user's answers, the user may click on links in this list to drill down and see further details of these requirements, as well as the configuration settings that are linked to the requirements. In another embodiment of the first mode, requirements information may be gathered using a search/select requirements tool 222. Search/select requirements tool 222 may be used to search and browse through requirements in the knowledgebase, and a company may select the relevant requirements that are applicable to its solution design. In one example, the search/select requirements tool 222 may allow the user to search by business process area, functional requirement type, and/or keyword search. Once the system has provided a list of the relevant requirements to the user based on the user's search criteria, the user may click on links in this list to drill down and see further details of these requirements, as well as the configuration settings that are linked to the requirements.

In the second mode, configuration information may be gathered using a search/select configurations tool 224. In this embodiment, known configuration settings are used to identify applicable requirements. For instance, the EASK utility may be used by a company when the company's enterprise system is already designed and running, and the company wants to document its existing solution design. In other words, the company that has already implemented a solution design knows its configuration settings. The company may enter the configuration settings into the EASK utility to reverse engineer and identify the matching functional requirements and automatically link them to the configuration settings. A requirement is said to ‘match’ with a configuration setting where the configuration setting is needed to enable the requirement in the enterprise application software. For example, a company implementing software to forecast their sales may have a requirement to forecast one year out into the future. In this case, the requirement may be the “Ability to develop a sales forecast in the forecasting system for a one year period in the future”. To enable this in an SAP Demand Planning software module, a “Time Bucket Profile” configuration may be created with a setting of “12” time periods, each with a time period of one month. In another example, a company implementing inventory management software to manage inventory at its warehouse may have a requirement to replenish inventory based on reorder point levels, i.e., the software should check if the current stock on hand is less than a reorder point, and if the current stock is less than the reorder point, place an order to replenish. The requirement may be stated as the “Ability to replenish stock when inventory falls below reorder point.” This requirement may be enabled by two configuration settings in the software: a boolean (TRUE/FALSE) setting for a “Replenish To Reorder Point” configuration which activates the algorithm to replenish stock with a “TRUE” setting, and a data field at the “Material Reorder Point” configuration object level which specifies the reorder point quantity for each material. The first configuration setting may activate the algorithm in the enterprise application software for replenishing stock to the reorder point, while the second configuration setting provides the actual value to use within the algorithm, i.e., the level to which each material should be replenished. Documenting existing solutions in such a manner creates a valuable knowledgebase for a support team, and also has many other uses.

To identify configurations to document, a user may browse through a listing of configurations in the application knowledgebase using the search/select configurations tool 224. Based on the modules/processes the company is using, a user may select the particular configurations that have been setup in the company's running enterprise software. In one example, the search/select configurations tool 224 may be used to browse configurations based on business process module, configuration type, and/or keyword search. The system may provide a list of the configurations to the user based on the user's search criteria, and the user may select one or more of the configuration objects to obtain more detail. Configuration objects may be selected at a very low level of detail, down to the field level. The user may use the list generated by the EASK utility and click on links to drill down and see further details of the listed configuration objects, as well as links to other configuration objects and matching functional requirements objects.

In another embodiment of the second mode, an auto configuration extraction tool 226 may be used to capture configuration knowledge automatically from commonly used enterprise software systems, such as, for example, SAP and Oracle. The auto configuration extraction tool 226 may map and match the configuration settings from the implemented enterprise software with configuration settings in the application knowledgebase. The auto configuration extraction tool 226 may obtain additional details of the configuration settings and the linkages to other objects from the application knowledgebase.

Regardless of whether the functional requirements are gathered using either the Q&A tool 220 or the search/select requirements tool 222, the matching engine 228 may find the configurations that “match” the gathered requirements and business process details. A configuration is said to “match” a given requirement if the configuration is required to enable the requirement in some manner. Each functional requirement may be enabled by one or more configurations. The relationships between configuration and requirement may be a one to one, one to many, many to one, or a many to many relationship. In other words, each requirement may be enabled by one or more configurations, and each configuration in turn may enable one or more requirements. Similarly, when configurations settings are gathered using search/select configuration tool 224 or auto configuration extraction tool 226, the matching engine 228 may find the requirements and business process details that “match” the gathered configurations settings. A requirement is said to “match” a given configuration if the requirement is enabled by the selected configuration in some manner. Thus, the matching engine 228 builds on the linkages between the configuration settings and the functional requirements that are defined in the application knowledgebase. Linkages may be present at various levels of the knowledgebase, thereby allowing for all details of the requirements and configurations to be provided.

The document project component 208 may be used to document a project design within a structured knowledgebase by creating a project knowledgebase directly without the use of an application knowledgebase. In other words, a user may use the EASK utility without the application knowledgebase 212 to document design knowledge, including knowledge such as detailed business requirements and detailed systems design. The knowledge may be documented in a structured format similar to the application knowledgebase. For instance, there are three modes to upload the knowledge: via a file upload tool 230 where a user inputs knowledge into a file which then is uploaded into the enterprise software; via a manual update tool 232 where a user enters the knowledge manually using a data input screen in the system; and via an auto extraction tool 234 where knowledge is captured automatically from commonly used enterprise software systems. Once the knowledge is uploaded/updated/extract, a project knowledgebase may be created. The document project component 208 may be also used by companies to create best practice knowledgebases that can be used for training or as a starting point for new implementations. Similar to a project knowledgebase, solution providers who have several experts on their teams may capture an expert's knowledge into the system as a best practices solution design, thus capturing the knowledge in detail into a structured knowledgebase. This best practice knowledgebase may be used to launch a new implementation or to train consultants or to use as a knowledge repository for capturing best practices. In addition, in some cases companies may want to create custom objects to address requirements that are not met by the standard “out-of-the-box” software. The document project component 208 also enables the documentation of these custom objects. Configurations may also include customizations that the enterprise software allows, which are needed in order to capture some unique customer requirements. These custom configurations may be created using a programming language such as ABAP in SAP and may include custom reports, programs, user exits, macros etc. In many cases, project knowledgebases may include content created from both an application knowledgebase and custom content directly added to the project knowledgebase.

The search, analyze, and report component 210 comprises tools that enable end users to browse and update knowledge in the structured project and application knowledgebase. These components may provide assistance to company personnel and support personnel in maintaining and supporting a system design in day-to-day usage, as well as in providing training data for software providers and consultants/experts. The search, analyze, and report component 210 may include search requirements tool 236 through which a user may search project or application knowledgebases to find particular functional requirements. A search may be performed in multiple ways, such as by using keywords, using requirements types, etc. Once a requirement is found, users may find configurations linked to a requirement using the linkages defined in the knowledgebase being searched. The EASK utility may store requirements and configurations in a knowledgebase as objects. A user may click on or otherwise select a requirements object to obtain additional details or attributes about the requirement, such as the system configuration settings that are needed to enable this requirement, process steps that are enabled by this requirement, scenarios under which this requirement is applicable, etc.

Similar to the search requirements process above, in one embodiment a search configurations tool 238 allows users to search for and find particular configuration settings down to their lowest level of detail. For instance, once a configuration setting is identified, the user may then use the built-in linkages in the knowledgebase to drill down further to see if there are any parent configuration objects or children configuration objects, related objects, linked requirements, relevant versions, etc. Since the knowledgebase is structured, when a functional requirement or configuration setting is searched for in the knowledgebase and found, using the built-in linkages in the knowledgebase, users can find other objects linked to the requirement or configuration setting (e.g., from the searched-for requirement locate the linked configurations; from the searched-for configuration setting locate the linked requirements, etc.). One example of a configuration parent-child linkage is the following: a configuration to set up a report that shows a sales forecast may be linked to a configuration for time profile which shows how many months/years/days to show in the report. For requirements: detailed requirements for sales forecasting may be grouped under a process requirement which says “Perform sales forecast”. Detailed requirements may include “Sales forecast should be performed every month”, “Sales forecast should be executed for a 2 year future horizon”, and “Sales Forecast should be generated using statistical methods applied on historical data”.

The analysis tool 240 provides the capability for a user to do various analyses on the information, such as “where used”, “scenario analysis”, among others. For example, the “where used” analysis allows a user to identify where a requirement or setting is used in the system to understand the impact that making a change to the requirement or setting will have on the system. Support personnel may use the enterprise application software knowledgebase system to answer “how-to” queries from users, perform an “impact analysis” of making changes in one configuration and how the change will impact other configurations and other processes/requirements, perform quick assessments of work effort involved to make a change, answer users' software questions quickly, document requirements and configuration changes that are made as the solution gets updated, etc. Also, as business strategy changes occur for a company, the company can use the EASK utility to determine the changes to their processes and systems needed to accommodate the strategy change. The EASK utility may also enable a user to study the new functionality in new software releases/upgrades, For instance, with the EASK utility, the user may quickly get to know the current systems configurations requiring changes with the upgrades, they can also determine quickly if any of the current custom programs can be met with standard functionality in new releases, and they can do side by side comparisons of changes in current release and new releases for processes supported and enabling system configurations.

For companies that have implemented the same enterprise software in multiple instances, across multiple geographies and/or multiple business units, the utility provides a mechanism to capture the solution implemented at these different instances and to do a side by side comparison of the process and system details implemented across these instances. This can be useful to assess the effort required to consolidate instances if required and can also reduce the amount of effort required to consolidate instances. The utility may also be used to document solution templates that can be implemented across multiple instances.

For companies that have purchased the enterprise software and are looking to issue an RFP (Request for Proposal) for a consulting partner, the EASK utility can be used to prepare an initial design to provide as part of the RFP. This process can be performed very quickly by users who do not have sufficient knowledge in the application.

The reports tool 242 offers users a full detailed view of requirements and configurations and their linkages between them. Examples of reports include, but are not limited to, a detailed view of all the requirements by a process area, a detailed view of all configurations by system module, and a consolidated view of all requirements and configurations for a process/module showing all detail including linkages and attributes. Customized reports may also be created as per the user's needs. For companies that have implemented the same enterprise application software in multiple instances, across multiple geographies, and/or multiple business units, the reports tool provides a mechanism to capture the solution implemented at these different instances and to perform a side by side comparison of the processes and system module details implemented across these instances. This information may be useful in assessing the effort required to consolidate instances if required and may also reduce the amount of effort required to consolidate instances. For enterprise software upgrades, companies may use this module to study the new functionality in the new releases, quickly get to know the current systems configurations that will require changes with the upgrades, determine if any of the current custom programs can be met with standard functionality in new releases, and perform side by side comparisons of changes in the current release and new releases for processes supported and enabling system configurations.

Update knowledge tool 244 provides users with the capability to keep the knowledgebases updated as enterprise software updates occur in response to business or technical changes. During the maintenance and support phase, companies may make changes to their enterprise application software designs. These changes may be prompted by business changes (e.g., acquisition of a new company) or system changes (e.g., upgrades). When these changes occur, business process and enterprise software updates may be required. As a result, content in the project knowledgebase need to be changed. Update knowledge tool 244 allows updates to be made to the project knowledgebase to capture these business/system design changes. Updates such as version changes may comprise large scale changes that require the use of refreshed application knowledgebases. The EASK utility provides a version-maintenance of solution design (e.g., requirements and configurations). As a company's business process changes, the requirements may change. Similarly, when systems are upgraded, the configurations may change. The EASK utility provides version-maintenance features that allow companies to update and maintain the knowledgebases such that the knowledge is in sync with system design and business requirements. Business process changes may require addition of new requirements. System changes may require adds/changes/deletions to system configuration settings captured in the knowledgebase. These changes can be made manually to the EASK utility or through a file upload tool which captures the changes. Alternatively, changes can also be made through auto extraction tools where system changes are automatically extracted directly from widely used systems such as SAP, Oracle, and Microsoft business application. The EASK utility may then map these applications to application knowledgebases to speed up the creation and maintenance of content.

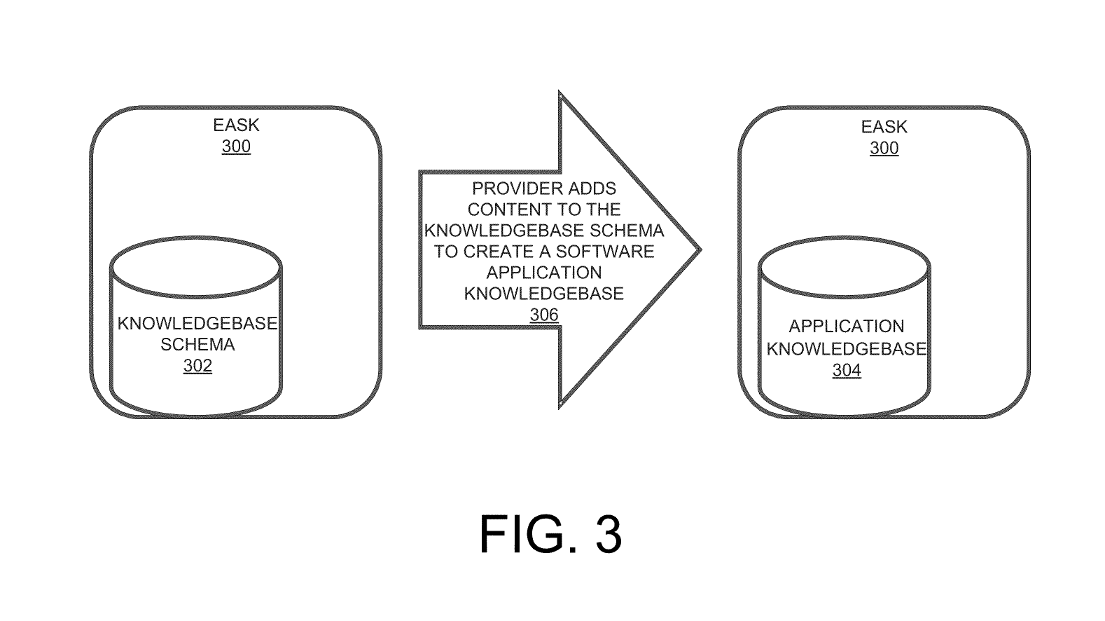

FIG. 3 is a diagram illustrating the creation of an application knowledgebase according to an illustrative embodiment. Through the EASK utility 300, users such as software providers or consulting service providers may add content to a knowledgebase schema 302 to create an application knowledgebase 304. The application knowledgebase may be stored within the database layer 202 in FIG. 2. The content 306 added to the knowledgebase schema 302 to create the application knowledgebase 304 may comprise configuration settings and the enabled requirements/processes, including from a high level of detail to the lowest level of detail. This detailed information is documented in the knowledgebase as objects. The objects may then be linked together as the users specify relationships between particular requirements and configurations. The EASK utility 300 facilitates the adding of content through an upload tool 204 as described in FIG. 2, including, for example, by uploading via upload tool 216 or through input screens provided in manual update tool 218.

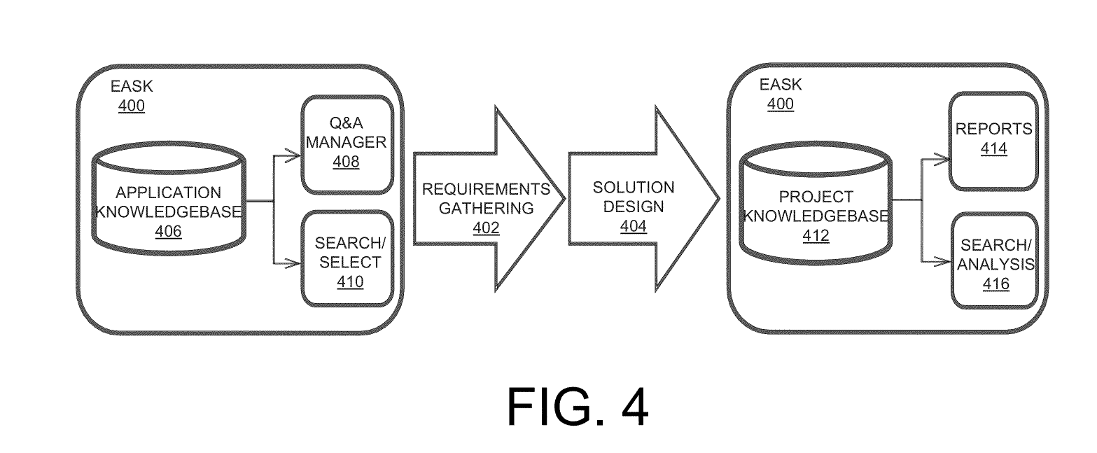

FIG. 4 is a diagram illustrating requirements gathering and design for an enterprise software implementation according to an illustrative embodiment. In particular, this diagram illustrates how the EASK utility 400, and in particular the Design & document component 206 in FIG. 2, may be used during the requirements gathering and the design phases of an implementation. Some companies separate requirements gathering and design as two separate phases in their implementation, and some refer to the design process as the ‘blueprinting’ phase. Generally, the activities involved during the requirements gathering phase 402 of an implementation comprise discussions with business users to gather business requirements and to gain a deep understanding of the company's current processes, various business/product scenarios, policies used, key data elements, etc. The design phase 404 may include mapping of the gathered requirements to the capabilities of the enterprise software, process design (typically includes an analysis of current as-is processes and the design of new to-be processes), and a final determination of detailed functional requirements including business policies for various possible business process scenarios. Together with the determination of the functional requirements and new/to-be processes, in the design phase, the implementation team may create the system design that is required to enable the functional requirements and new processes; the system design may include the system configuration settings such as user screens, tables, reports, data fields, flags, macros, profiles, user exits, transaction codes, configuration objects, etc.

As shown in this illustrative embodiment, the EASK system 400 may be used for requirements gathering through two modes: Q&A and search/select. The Q&A tool 408 is an example of the Q&A tool 220 in FIG. 2, and may sit on top of the application knowledgebase 406. An implementation team may use the Q&A tool 408 together with business users/business experts to walk through various questions and answers that are geared towards the company's business processes and industry. The questions and answers may have a logical sequence and dependencies among them are built-in to the tool. Based on the answers to the questions, individual requirements provided from the application knowledgebase 406 are selected by the implementation team. The end result is a list of selected company-relevant detailed functional requirements, business/product scenarios, and business process steps derived from the application knowledgebase based on the user selected answers to the questions. Examples of scenarios include supply chain strategies such as “Make to Stock” vs. “Make to Order”, or production methods such as “Manufacturing in House” vs. “Subcontracting” or sales scenarios such as “US Customers” vs. “International Customers”. Scenarios may provide additional detail to the requirements, and certain requirements may apply only to one or more scenarios. For example, a company may state the requirement “Ability to handle multiple currencies in Sales Order Management systems” may apply only to the Scenario of “International Customers”. Business process steps are detailed steps within each business process. For example, a business process for “New Sales Order Entry” may include steps to (1) enter a customer's name, (2) enter the customer's address, (3) enter a quantity of purchase, etc.

The search/select tool 410 also sits on top of the application knowledgebase 406 and may also be used to gather requirements. The search/select tool 410 is an example of the search/select requirements tool 222 in FIG. 2. In this mode, instead of using a question and answer mode, the implementation team working with business users may search the application knowledgebase 406 using keywords and search terms to identify requirements. The search/select tool 410 may return a list of requirements provided by the application knowledgebase 406. The implementation team may review this list of company-relevant detailed functional requirements, process scenarios, and business process steps, and select a set of individual requirements.

In either the Q&A mode or search/select mode, the selected requirements may be stored as data objects by the EASK utility 400. Users may add additional details/attributes to these requirements, such as specific details on why the requirement was chosen, which scenario such as business unit or product line that the requirement applies to, etc. For instance, a user may add an attribute to a requirement that specifies that the requirement is only applicable to U.S. customers and not international customers. (An example of how this may be implemented is a requirement for a sales associate to collect a customer's phone number for a sales order—the sales associate will be required to collect a phone number for U.S.-based customers, but not for international customers.) In addition, the requirements may comprise attributes that enable the requirements to be classified as one or more requirement types. Some example requirement types include, but are not limited to, a business policies type, a business rules type, etc. This type classification may be helpful to personnel in the support phase as they may search for specific types of requirements and also for generating reports to analyze requirements.

Once the functional requirements are determined, the system design may be prepared based on the identified requirements. A matching engine (‘solution designer’), such as matching engine 228 in FIG. 2, may be used to match the requirements selected by the implementation team to system configuration settings in the application knowledgebase. The system configuration settings can include flags, field selections, parameters, transaction codes, user screen parameters, profile settings, macros, among others. The end result of this process may be a completed solution design which includes both the detailed business processes and requirements and also the system configurations. The completed solution design, derived from the application knowledgebase 406, may be saved in a project knowledgebase 412. Search, analysis, and reporting functions, such as report tool 414 and search/analysis tools 416 are available to support and train personnel to easily search for and locate functional and technical details of the project design. Report tool 414 and search/analysis tools 416 are examples of tools provided by the search/analyze/report component 210 in FIG. 2.

In addition to these requirements and configurations, a company may also develop custom objects when the requirements cannot be exactly met by the enterprise application software. Custom objects may comprise requirements and configurations that are not part of the application knowledgebase 406. These objects may be directly added to the project knowledgebase 412 by a user through an input screen in the enterprise application software knowledgebase system or through a file upload. All of the linkages established between and across the various system configuration settings and functional requirements may be carried over from the application knowledgebase 406 to the project knowledgebase 412. Propagating the linkages to the project knowledgebase 412 also accomplishes the task of documenting the project design. In one example, no additional documentation activity is required as all details can be captured in the project knowledgebase 412 during the requirements gathering and system design phase(s) as described below.

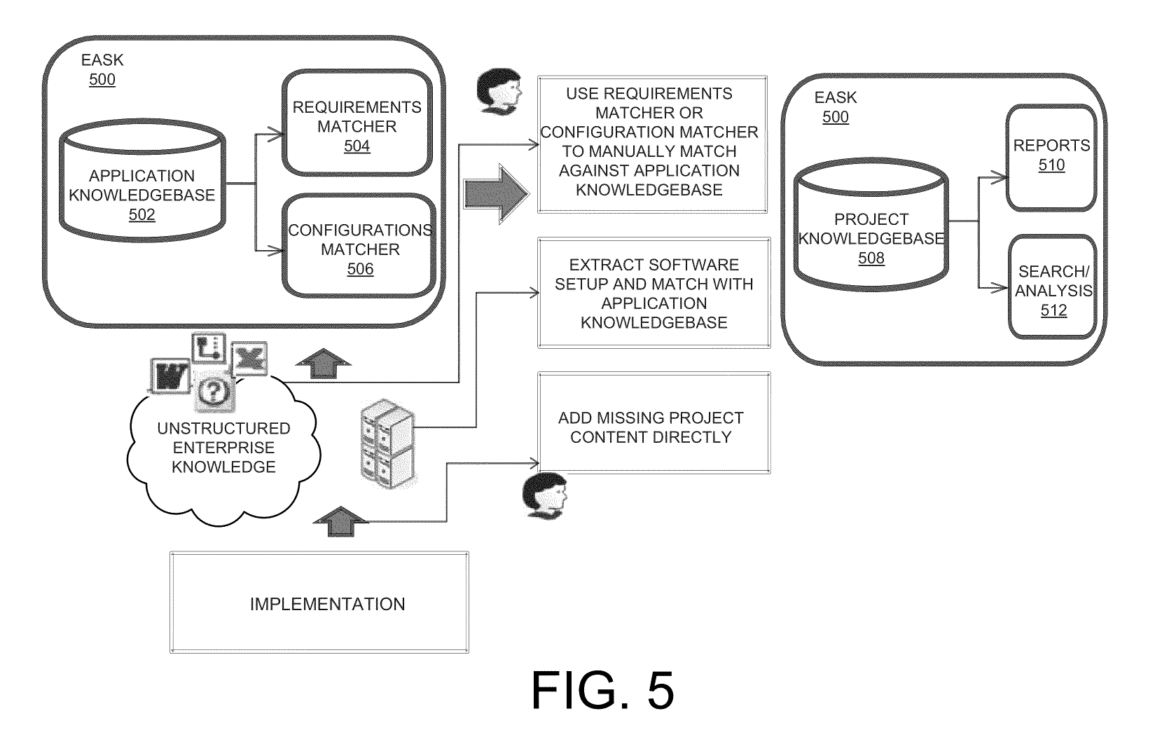

FIG. 5 is a diagram further illustrating design documentation using application knowledgebases according to an illustrative embodiment. A company may desire to use the EASK utility for documentation purposes. Documenting comprises creating a project knowledgebase using the application knowledgebase as a starting aid. For example, a company that may have already implemented an enterprise software solution may use the EASK utility to document that solution. The EASK utility allows the company to document knowledge in a structured knowledgebase, which makes the knowledge easier to find, update, and maintain for support personnel.

The EASK utility 500 provides multiple modes to perform the documentation: a requirements documentation match mode 504 and a configuration documentation match mode 506. In the requirements documentation match mode, a company may use the application knowledgebase 502 to perform requirements gathering through Q&A or search/select tools, as described in FIG. 2. The company may select the requirements that have already been implemented and, in the process of doing so, document the functional requirements already implemented. As the company goes through the selection of requirements, they may also add more details on the requirements, such as, for example, business/product scenarios applicable to a requirement, reasons why a requirement is relevant, among others. In the configuration documentation match mode, a company may use the EASK utility 500 to first document the configuration settings they have implemented or identified for implementation, and then reverse engineer to identify the requirements for their business processes. A company may capture configuration settings through a configuration search/select or an auto configuration extraction tool as described in FIG. 2.

Once the company selects a set of requirements, a matching engine may be used to retrieve a list of the configuration settings that are ‘matched’ to the selected requirements based on the linkages defined in the application knowledgebase. Similarly, once the company selects a set of configuration settings, the matching engine may be used to retrieve a list of the requirements that are matched to the selected configuration settings based on the linkages defined in the application knowledgebase. These requirements and configuration settings may then be saved into the project knowledgebase 508 for that implemented solution design. A user may also opt to employ an auto configuration extraction tool to automatically extract the software setup and match against the application knowledgebase or a manual update tool to add missing system data directly to the project knowledgebase.

Regardless of the method of adding solution design knowledge, the relevant requirements and configuration settings that are part of an implemented solution design may easily be captured in a project knowledgebase. The company now has a complete project knowledgebase by business area/module. The project knowledgebase may document the full system design as implemented.

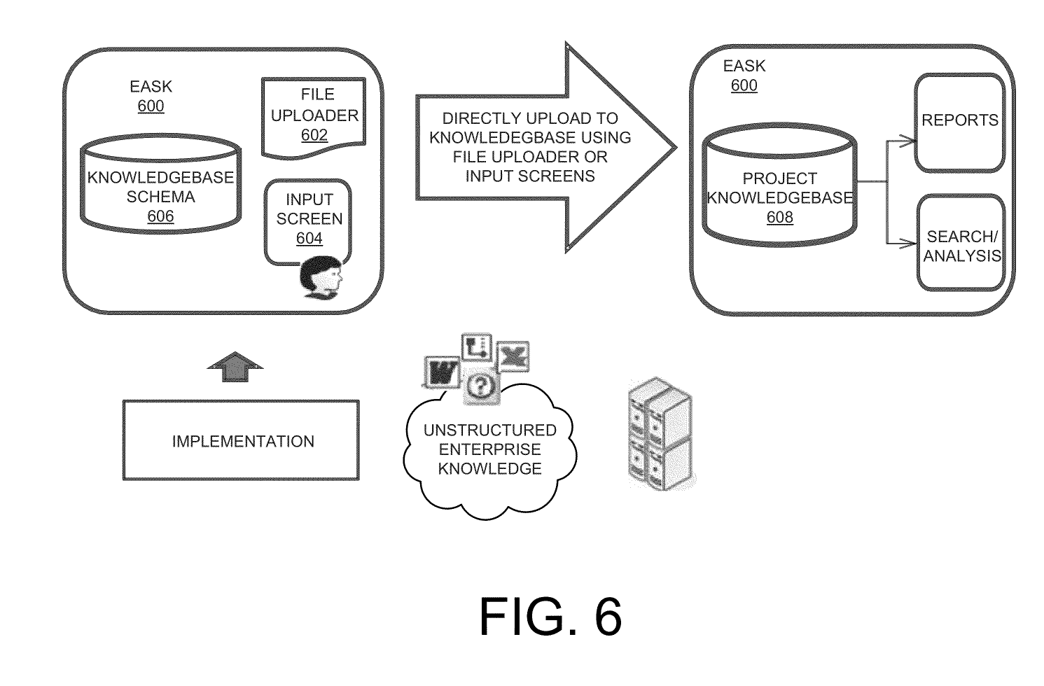

FIG. 6 is a diagram further illustrating design documentation without application knowledgebase according to an illustrative embodiment. This embodiment may be used when an application knowledgebase is not available. In such a scenario, a company may still document its project knowledgebase settings directly into the EASK utility 600 without using the application knowledgebase. A user may input knowledge into the project knowledgebase using a file upload 602 or a manual update 604. Using an upload tool such as upload module 230 in FIG. 2, a user may upload the functional requirements and configuration settings for an implemented design into the format of the knowledgebase schema 606. In one example, the file may comprise a flat file or an Excel file. The user uploads the file directly into a knowledgebase to form a project knowledgebase 608. In another embodiment, the user may manually input the knowledge through an input screen(s) in the enterprise application software knowledgebase system. The screen(s) may be setup using object templates for various types of knowledge objects, such as, for example, types for functional requirements and system configuration settings which may be specific to the business area/system module/software provider.

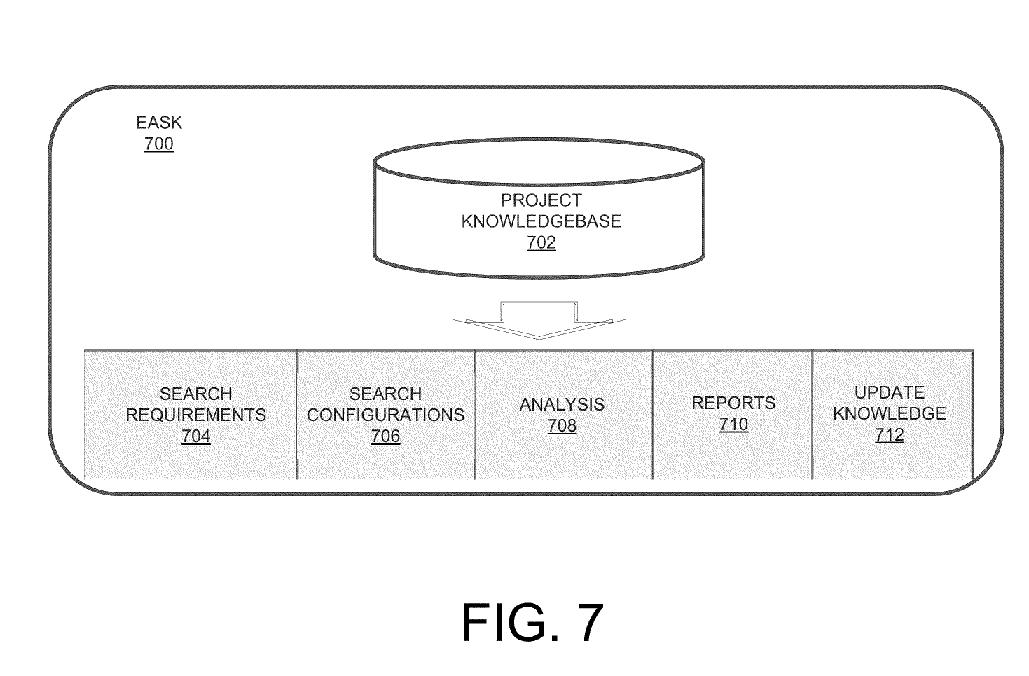

FIG. 7 is a diagram illustrating tools a user may use to access and update a project knowledgebase according to an illustrative embodiment. As also described in blocks 236-244 in FIG. 2, various search, analysis, and reporting tools are provided by the EASK utility 700 to enable a company to maintain and support the company's enterprise software. The tools may be used by the company to browse and update knowledge in the structured project knowledgebase 702. For example, the search requirements tool 704 may be used by the company to search the project knowledgebase for known requirements. Since the knowledgebase is structured, once a requirement is found, using the built-in linkages, configuration setting objects linked to the requirement are identified and provided to the user. Similarly, the search configuration tool 706 may be used to search the project knowledgebase for known configuration settings. When a configuration setting is found, the user may identify requirement objects that are linked to that configuration setting. Thus, support personnel may utilize the search tools to input known information and then identify objects that have been linked to the known information.

In addition, the analysis tool 708 may be used by the company to identify where in the enterprise software a system configuration setting or requirement is used. Knowing all of the places in which a configuration setting or requirement is used enables a user to understand the impact that making a change to the setting or requirement will have on the enterprise software. For instance, a “where used” analysis allows the user to analyze the impact of making a change to a configuration setting which may be used to support several requirements.

The company may also utilize the reporting tool 710 to obtain from the project knowledgebase a full detailed view of a set of requirements, configuration settings, and their linkages. Example reports may include a detailed view of all the requirements by a single process area, a detailed view of all configurations by system module, a detailed view of requirements by requirement type or under a process step or a consolidated view of all requirements and configurations for a process/module showing all detail including linkages and attributes.

The company may also update the project knowledgebase as enterprise software updates occur through update tool 712. These updates may reflect changes that occur in response to business or technical changes in the software.

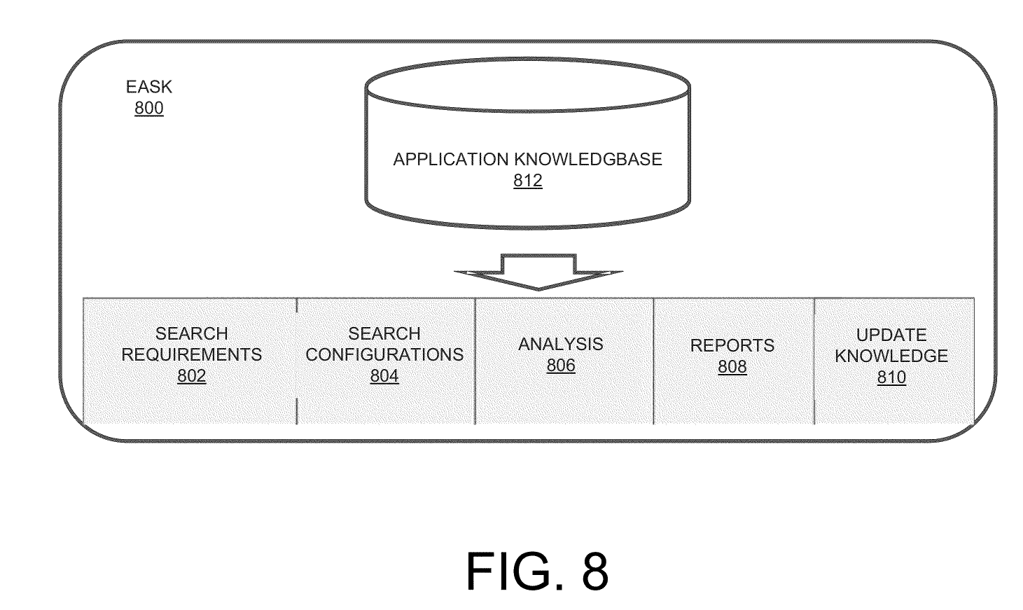

FIG. 8 is a diagram illustrating an example training/reference utility for enterprise software providers or consulting services providers according to an illustrative embodiment. Similar to the search and analysis capabilities described in FIG. 7, the EASK utility 800 provides various search, analysis, and reporting tools that may be used by enterprise software providers or consulting service providers to train provider personnel or to use as an additional reference knowledgebase for company personnel. These tools, such as search requirements tool 802, search configuration tool 804, analysis tool 806, reports tool 808, and update knowledge tool 810 may perform similar functions as the components in FIG. 7. However, these components may be used by enterprise software providers or consulting companies to obtain information from an application knowledgebase 812 when training personnel or to be used as a reference for consulting personnel or support personnel to use.

For instance, enterprise software providers and consulting companies may populate/add content to an EASK utility 800 through the upload 212 and manual update 214 tools previously discussed in FIG. 2. This content may be added to create best practice knowledgebases, and these knowledgebases may be used by the providers to train new consultants. Consultants may then use these knowledgebases during new implementations of enterprise application solutions, as well as during the maintenance and support of implemented solutions. They may also be used as reference knowledgebases by consultants. In addition, companies that provide outsourced enterprise software support services may document system designs using the EASK utility 800 and then use these documented designs to provide support and maintenance. Regardless of how the application knowledgebase/best practices knowledgebase is used, users benefit from having knowledge maintained in a single knowledgebase and having the content in a structured format and usable for quickly training support and provider personnel.

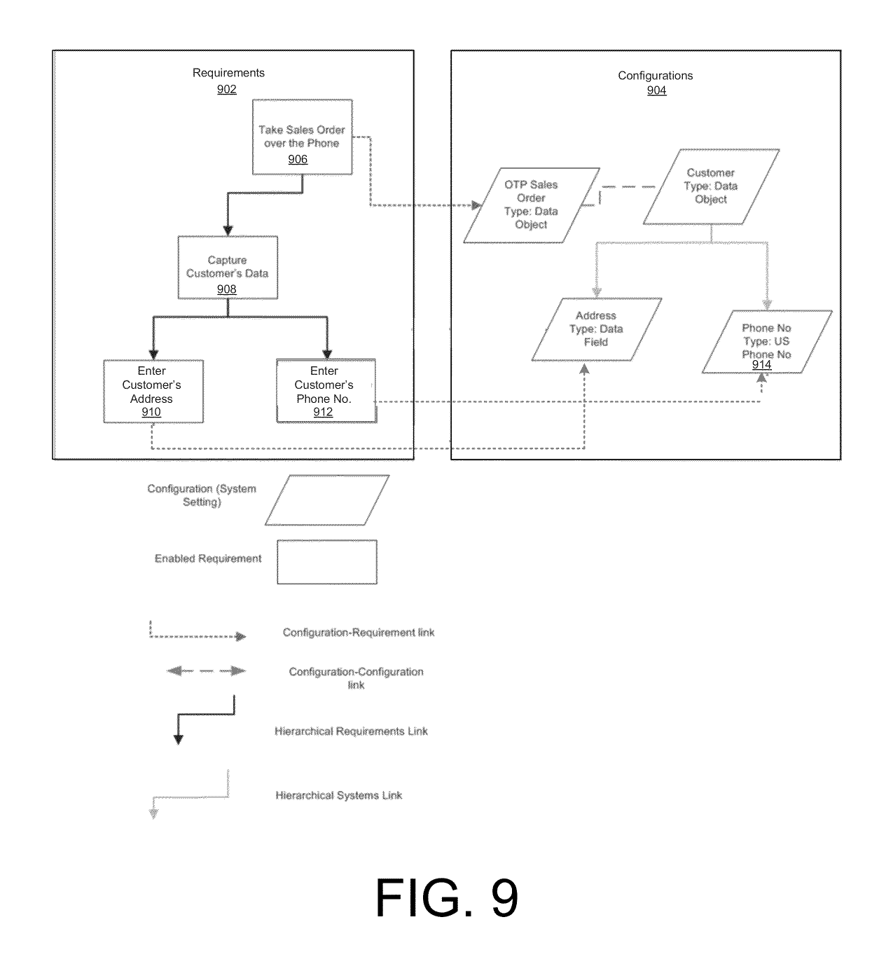

FIG. 9 is a diagram illustrating example objects within EASK according to an illustrative embodiment. In particular, FIG. 9 shows a simple example of how requirements 902 and configurations 904 can be setup within a knowledgebase. Consider a business process step in which a company sales representative takes sales orders on the phone. The sales representative needs to capture the customer orders into an enterprise application software. The functional requirements for the system may be the ability to enter a customer's address, and the ability to enter a customer's phone number during order entry. These requirements may be documented in the EASK knowledgebase using the following requirement objects: a high level sales order requirement object ‘Take Sales Order over the Phone’ 906, a customer order entry requirement object ‘Capture Customer's Data’ 908, the data fields address capture requirement object ‘Enter Customer's Address’ 910 and a phone number capture requirement object ‘Enter Customer's Phone No.’ 912.

The diagram shows the relationship and linkages between the various objects. These objects may be stored as content in the EASK utility and the linkages among the objects may also be represented in the knowledgebase providing an efficient mechanism for support personnel to find information needed to address issues with the enterprise application software. For instance, consider a situation where a sales representative is not able to enter a customer's international phone number into the enterprise application software and thus posts a help request to the support personnel. The support person can check or search using the EASK utility and identify the requirement “Enter customer's phone no.” 912 and see that the reported issue is caused due to the ‘customer's phone no’ field being configured to handle only domestic U.S. phone numbers, as shown by linked configuration object 914.

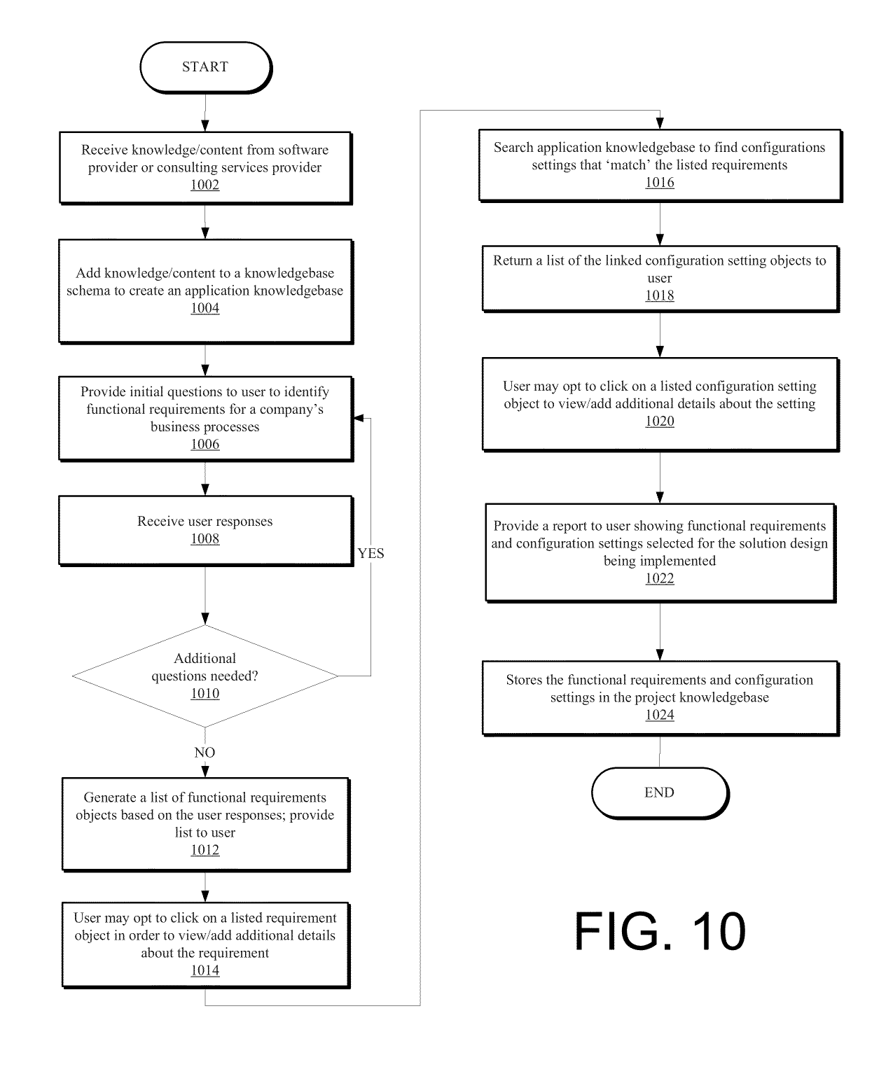

FIG. 10 is a flowchart of a process in the EASK utility for gathering requirements and creating a solution design for a new enterprise software implementation using a Q&A tool according to an illustrative embodiment. In one embodiment, the new enterprise software may have been purchased by a company who now wants to implement the solution to aid their business processes. The process begins with the EASK utility receiving knowledge/content from a user, such as the software provider or consulting services provider (step 1002). The user may provide the knowledge/content by way of a file upload or a manual update of the content through the EASK utility. The EASK utility may add the knowledge/content to a knowledgebase schema stored within a database in the EASK utility and create an application knowledgebase that comprises the knowledge/content (step 1004). The knowledge/content may include requirements, configuration settings, linkages, attributes, and other details for a business process area.

Once the application knowledgebase is created, the user may use the application knowledgebase and EASK utility to create a solution design for the company through a question and answer session. The EASK utility provides one or more initial questions to a user that seeks to identify functional requirements for a company's business processes (step 1006). The EASK utility may receive the user's responses to the questions, as well as additional information specifying the specific business scenarios where the response content may be applicable (step 1008). A determination may be made as to whether additional questions should be asked to gather further details about the company's business processes (step 1010). If additional questions may be asked, the process may return to step 1006 and provide additional questions to the user, wherein these questions provided are based on the previous responses from the user. In one embodiment, each set of questions are designed to probe deeper for more granular detail about the company's business processes, such that the levels of detail, beginning from the highest and most general to the lowest and most detailed, about the processes may be discovered by the EASK utility.

If all of the applicable questions have been provided to and answered by the user, the EASK utility may generate a list of functional requirements objects based on the user responses and provide a list of these requirements to the user (step 1012). The user may opt to click on a listed requirement object in order to view additional details about the requirement and/or to add additional details to the requirement (step 1014).

Once the applicable requirements list is provided to the user, the EASK utility may search the application knowledgebase to find configurations settings in the knowledgebase that ‘match’ (e.g., are linked to) the listed requirements (step 1016). A configuration setting may be determined to be associated with a requirement based on linkages between the configuration settings objects and the requirements objects as specified in the application knowledgebase. For example, a configuration setting may be linked to a requirement when the setting enables the requirement. The EASK utility may then return a list of the linked configuration setting objects to the user (step 1018). The user may opt to click on a listed configuration setting object to see additional details about the setting and/or to add additional details to the setting (step 1020).

The EASK utility may then provide a report to the user that shows the functional requirements and the configuration settings selected for the solution design being implemented for the company (step 1022). The EASK utility stores the functional requirements and configuration settings in a project knowledgebase (step 1024) such that the solution design may be later accessed and updated by personnel for software maintenance and support.

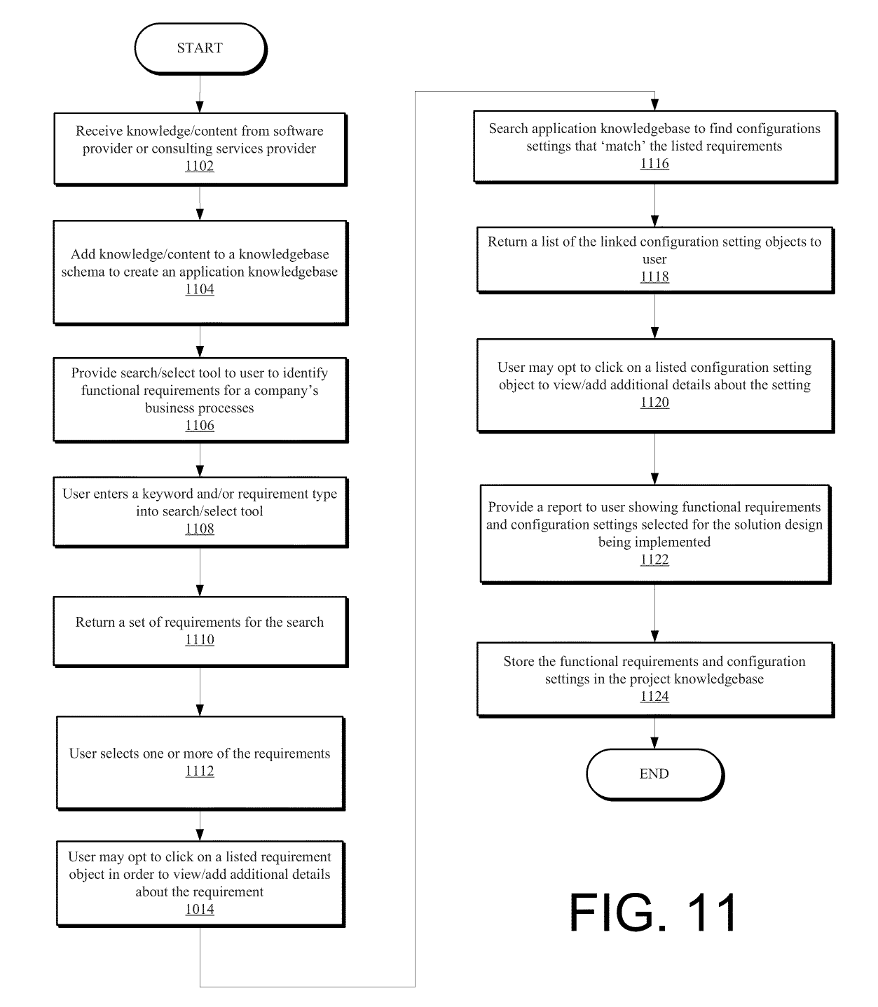

FIG. 11 is a flowchart of a process in the EASK utility for gathering requirements and creating a solution design for a new enterprise software implementation using a search/select tool according to an illustrative embodiment. Similar to the process in FIG. 10, the process in FIG. 11 begins with the EASK utility receiving knowledge/content from a user, such as the software provider or consulting services provider (step 1102). The knowledge/content may be provided by way of a file upload or a manual update of the content through the EASK utility. The EASK utility may then add the knowledge/content to a knowledgebase schema stored within a database in the EASK utility and create an application knowledgebase that comprises the knowledge/content (step 1104) of requirements, configuration settings, linkages, attributes, and other details for a business process area.

The user may employ the application knowledgebase and the EASK utility to create a solution design for the company through a search/select tool. The EASK utility gathers functional requirements for the company's business processes by first providing the search/select tool to the user (e.g., software provider or consultant) (step 1106). The user may then select a business process area and enter a keyword and/or requirement type into the search/select tool (step 1108). The EASK utility may return a set of requirements for the search (step 1110), and the user may select one or more of the requirements (step 1112). The user may also opt to click on a listed requirement to view additional details about the requirement and/or to add additional details (e.g., scenarios) to the requirement (step 1114).

Once the requirements are identified by the utility, the EASK utility may search the application knowledgebase to find configurations settings objects in the knowledgebase that ‘match’ (e.g., are linked to) the listed requirements (step 1116) and provide a list of these linked configuration settings objects to the user (step 1118). The user may opt to click on a listed configuration setting object to see additional details about the setting and/or to add additional details to the setting (step 1120).

The EASK utility may then provide a report to the user that shows the functional requirements and the configuration settings selected for the solution design being implemented (step 1122). The EASK utility stores the functional requirements and configuration settings in a project knowledgebase (step 1124) such that the solution design may be later accessed and updated by personnel for software maintenance and support.

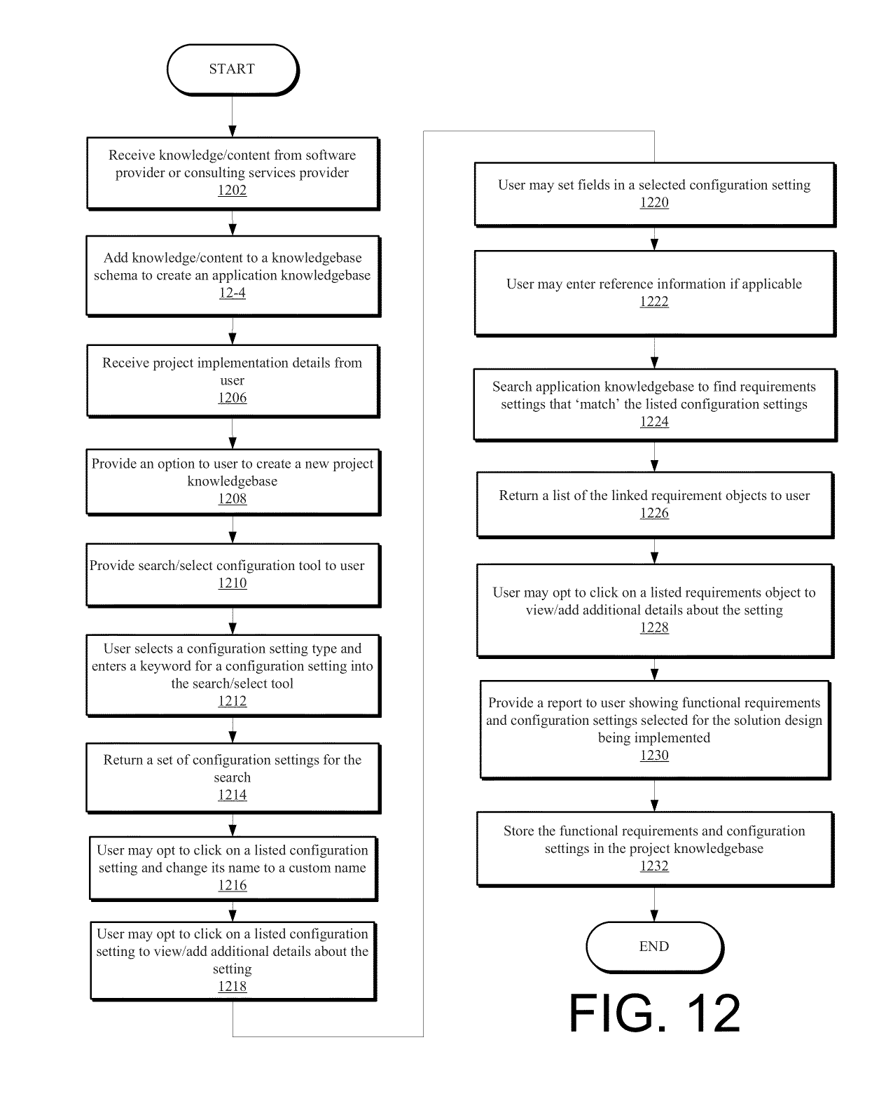

FIG. 12 is a flowchart of a process for creating a project knowledgebase by capturing current enterprise software configuration settings according to an illustrative embodiment. The process in FIG. 12 begins with the EASK utility receiving knowledge/content from a user, such as the software provider or consulting services provider (step 1202). The knowledge/content may be provided by way of a file upload or a manual update of the content through the EASK utility. The EASK utility may then add the knowledge/content to a knowledgebase schema stored within a database in the EASK utility and create an application knowledgebase that comprises the knowledge/content (step 1204) of requirements, configuration settings, linkages, attributes, and other details for a business process area.

The EASK utility may then receive project implementation details from a user (step 1206). In one embodiment, the EASK utility may provide one or more dropdown boxes to the user to allow the user to specify aspects of the company's enterprise software implementation for the current project. For example, if the company has already implemented the Advanced Planner and Optimizer (APO) module and Demand Planning (DP) component in an SAP Supply Chain Management (SCM) enterprise software system, the user may select the system (e.g., SAP SCM), the module (SAP APO), and the component (APO DP) from the dropdown boxes.

Upon receiving the implemented system details from the user, the EASK utility may provide an option to the user to create a new project knowledgebase (step 1208). When the new project knowledgebase option is chosen by the user, the EASK utility may provide the user with a search/select configuration settings tool (step 1210). The search/select configuration settings tool allows the user to search for and add configuration settings from the application knowledgebase to the new project knowledgebase. The user may select a configuration setting type from a dropdown box (or select ‘all’ to search all types) and enter a keyword for a configuration setting into the search/select tool (step 1212). The EASK utility returns a set of configuration settings for the search (step 1214).

The user may also opt to click on a listed configuration setting and change its name to a custom name (step 1216). The user may further opt to click on a listed configuration setting to view additional details about the setting and/or to add additional details (e.g., scenarios) to the setting (step 1218).

The EASK utility also enables the user to set fields in a selected configuration setting by selecting the fields from dropdown lists or by entering the values into the knowledgebase system (step 1220). The user may also be allowed to enter reference information if applicable, such as screen shots of configuration setup (step 1222).

Once the configuration settings are identified by the utility, the EASK utility may search the application knowledgebase to find requirements objects in the knowledgebase that ‘match’ (e.g., are linked to) the listed configuration settings (step 1224) and provide a list of requirements objects that are associated/linked to the listed configuration setting (step 1226). The user may opt to click on a listed requirements object to see additional details about the requirement and/or to add additional details to the requirement (step 1228).

The EASK utility may then provide report to the user that shows the captured configuration objects by type and the matching functional requirements (step 1230). The EASK utility stores the functional requirements and configuration settings in a project knowledgebase (step 1232) such that the solution design may be later accessed and updated by personnel for software maintenance and support.

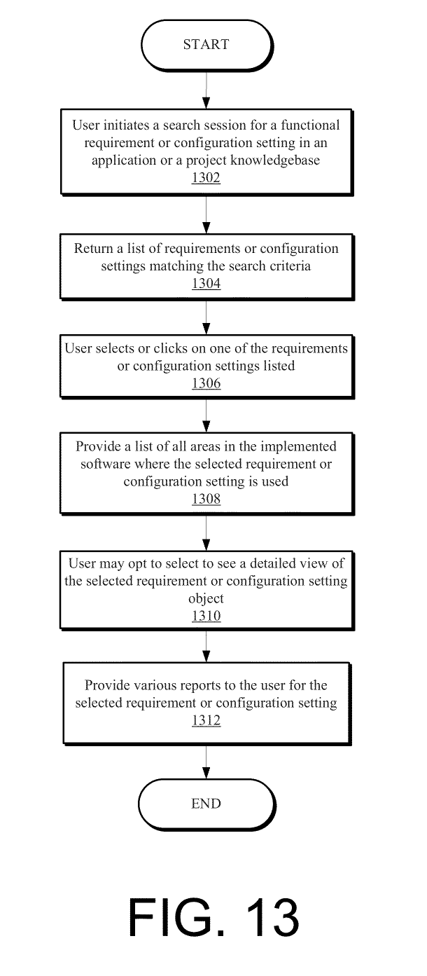

FIG. 13 is a flowchart of a process for using a knowledgebase to find functional requirements and configuration settings about an implemented enterprise solution according to an illustrative embodiment. The process provides an example of determining where a functional requirement or configuration setting is used in an implemented solution to know what areas of the solution will be impacted from a change to the requirement or configuration setting.

The process begins with a user initiating a search session in the EASK utility for a functional requirement or configuration setting in an application knowledgebase or a project knowledgebase (step 1302). The EASK utility returns a list of requirements or configuration settings matching the search criteria (step 1304). When the user selects or clicks on one of the requirements or configuration settings listed (step 1306), the EASK utility may provide a list of all of the areas in the implemented software where the selected requirement or configuration setting is used (step 1308). These areas where the selected requirement or configuration setting is used may be the areas which will be impacted by a change to the selected requirement or configuration setting. They may include areas comprising the selected requirement or configuration setting object or other objects linked to the selected requirement or configuration setting object. The user may also select an option to see a detailed view of the selected requirement or configuration setting object (step 1310). In one embodiment, this view may comprise a drill down view of the requirements or configuration settings objects linked to the selected requirements or configuration settings objects from a higher level to a lower level of detail.

For the selected requirement or configuration setting, the EASK utility may provide various reports to the user for the selected requirement or configuration setting (step 1312), including, for example, a detailed view of an individual requirement including linkages and attributes, a detailed view of an individual configuration setting including linkages and attributes, or a consolidated view of all of the requirements and configuration settings returned including linkages and attributes.

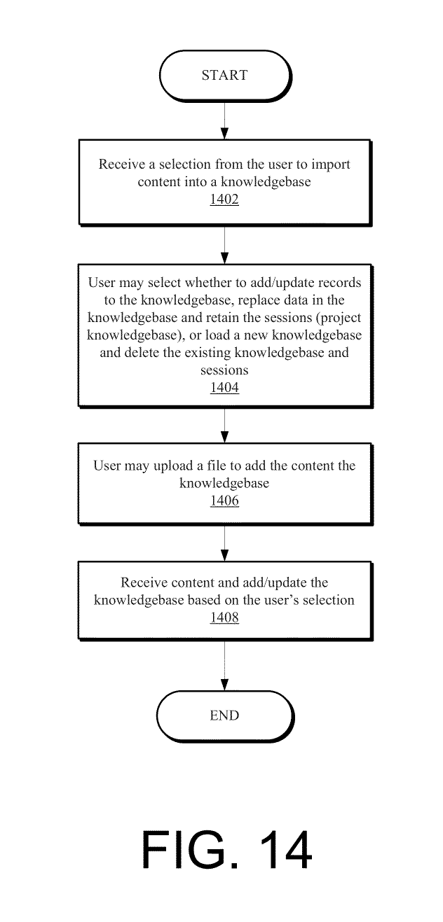

FIG. 14 is a flowchart of a process for creating new knowledgebases or updating existing knowledgebases according to an illustrative embodiment. In one embodiment, the process in FIG. 14 comprises additional details of the process performed in steps 1002-1004, 1102-1104, and 1202-1204 in FIGS. 10, 11, and 12, respectively.

The EASK utility receives a selection from the user to import content into a knowledgebase (step 1402). The user may select whether to add/update records to the knowledgebase, replace data in the knowledgebase and retain the sessions (project knowledgebase), or load a new knowledgebase and delete the existing knowledgebase and sessions (step 1404). The user may then upload a file to add the content the knowledgebase (step 1406). The EASK utility receives the content and adds/updates the knowledgebase based on the user's selection (step 1408).

It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, use of the term “a set” may refer to one or more of an item.

Thus, the various illustrative embodiments provide a structured knowledgebase system for documenting solution designs of enterprise software to reduce the time and costs of implementing and maintaining a solution. The advantages of the embodiments should be apparent in view of the detailed description provided above. The EASK utility provides for comprehensive requirements gathering and design by ensuring that requirements are captured in a very high level of detail. Without the EASK utility, a project team must make sure all details are captured manually. In later stages of the project or after go-live, companies often may have to go back and adjust their systems after they find out requirements were missed. With the EASK utility, one may be confident that every level of detail of the requirements may be comprehensively captured and documented. By ensuring the requirements are comprehensively captured, through a “matcher” utility, the solution design prepared using the EASK utility is also comprehensive.

The EASK utility also enables companies to reduce costs significantly. For instance, using the utility enables a company to eliminate the need to document in multiple documents during implementation. In addition, training costs for new personnel in support and analysis roles may also be reduced as detailed information about the implemented solution in the structured knowledgebase is in an easy to access format. In addition, productivity of an organization providing support to a company may be improved as the support personnel may obtain needed answers more quickly from the knowledgebase and may be freed up to perform more value added activities.

The EASK utility also reduces a company's dependency on key personnel since the information that those particular people know is now captured in a knowledgebase. Consequently, others, especially newer personnel, may rely on the system by searching and locating desired information from the knowledgebase. Thus, the EASK utility helps a company handle transition of key personnel more effectively by making sure that a great deal of knowledge is captured and retained in a easily searchable format to enable the new personnel to be brought up to speed quickly.

The EASK utility also improves the end user usability and acceptance of an enterprise software solution by providing quick and accurate resolution to issues and questions and results in greater end-user satisfaction for the enterprise software. In addition, the system may increase the use of standard functionality in the enterprise software, reduce customization, and also ensure a sound solution design since there is no dependence on the skills and knowledge levels of the consultants. As a company's business strategy changes, making changes to the processes and enabling software becomes cheaper because of the knowledgebase. Also, costs and timelines for upgrades of application software and for consolidating multiple instances of application software may be reduced.

Referring to FIG. 15, a block diagram of a computing device 1502 is shown in which the illustrative embodiments may be implemented. In particular, the EASK utility, as described in any of the illustrative embodiments, may be implemented on the computing device 1502. Computer-usable program code or instructions implementing the processes used in the illustrative embodiments may be located on the computing device 1502. The computing device 1502 includes a communications fabric 1503, which provides communication between a processor unit 1505, a memory 1507, a persistent storage 1509, a communications unit 1511, an input/output (I/O) unit 1513, and a display 1515.

The processor unit 1505 serves to execute instructions for software that may be loaded onto the memory 1507. The processor unit 1505 may be a set of one or more processors or may be a multi-core processor, depending on the particular implementation. Further, the processor unit 1505 may be implemented using one or more heterogeneous processor systems in which a main processor is present with secondary processors on a single chip. As another illustrative example, the processor unit 1505 may be a symmetric multi-processor system containing multiple processors of the same type.

The memory 1507, in these examples, may be, for example, a random access memory or any other suitable volatile or non-volatile storage device. The persistent storage 1509 may take various forms depending on the particular implementation. For example, the persistent storage 1509 may contain one or more components or devices. For example, the persistent storage 1509 may be a hard drive, a flash memory, a rewritable optical disk, a rewritable magnetic tape, or some combination of the above. The media used by the persistent storage 1509 may also be removable. For example, a removable hard drive may be used for the persistent storage 1509.

The communications unit 1511, in these examples, provides communication with other data processing systems or communication devices. In these examples, the communications unit 1511 may be a network interface card. The communications unit 1511 may provide communication through the use of either or both, physical and wireless communication links.

The input/output unit 1513 allows transferring data from/to other devices that may be connected to the computing device 1502. For example, the input/output unit 1513 may provide a connection for user input through a keyboard and mouse. Further, the input/output unit 1513 may send output to a processing device. The display 1515 provides a mechanism to display information to a user, such as a graphical user interface.

Instructions for the operating system and applications or programs are located on the persistent storage 1509. These instructions may be loaded onto the memory 1507 for execution by the processor unit 1505. The processes of the different embodiments may be performed by the processor unit 1505 using computer-implemented instructions, which may be located in a memory, such as the memory 1507. These instructions are referred to as program code, computer-usable program code, or computer-readable program code that may be read and executed by a processor in the processor unit 1505. The program code in the different embodiments may be embodied on different physical or tangible computer-readable media, such as the memory 1507 or the persistent storage 1509.

Program code 1517 is located in a functional form on a computer-readable media 1519 and may be loaded onto or transferred to the computing device 1502 for execution by the processor unit 1505. The program code 1517 and the computer-readable media 1519 form computer program product 1521 in these examples. In one embodiment, the computer program product 1521 is the EASK utility described in any of the illustrative embodiments. In this embodiment, the program code 1517 may include computer-usable program code capable of gathering and documenting requirements or configurations, as described in any of the illustrative embodiments herein. Indeed, any combination of the processes described in the illustrative embodiments may be implemented in the program code 1517.

In one example, the computer-readable media 1519 may be in a tangible form, such as, for example, an optical or magnetic disc that is inserted or placed into a drive or other device that is part of the persistent storage 1509 for transfer onto a storage device, such as a hard drive that is part of the persistent storage 1509. In a tangible form, the computer-readable media 1519 also may take the form of a persistent storage medium, such as a hard drive or a flash memory that is connected to the computing device 1502. The tangible form of the computer-readable media 1519 is also referred to as computer recordable storage media.

Alternatively, the program code 1517 may be transferred to the computing device 1502 from the computer-readable media 1519 through a communication link to the communications unit 1511 or through a connection to the input/output unit 1513. The communication link or the connection may be physical or wireless in the illustrative examples. The computer-readable media 1519 may also take the form of non-tangible media, such as communication links or wireless transmissions containing the program code 1517. In one embodiment, the program code 1517 is delivered to the computing device 1502 over the Internet.

The different components illustrated for the computing device 1502 are not meant to provide architectural limitations to the manner in which different embodiments may be implemented. The different illustrative embodiments may be implemented in a data processing system including components in addition to or in place of those illustrated for computing device 1502. Other components shown in FIG. 15 can be varied from the illustrative examples shown.

As one example, a storage device in the computing device 1502 is any hardware apparatus that may store data. The memory 1507, the persistent storage 1509, and the computer-readable media 1519 are examples of storage devices in a tangible form.

In another example, a bus system may be used to implement the communications fabric 1503 and may comprise of one or more buses, such as a system bus or an input/output bus. Of course, the bus system may be implemented using any suitable type of architecture that provides for a transfer of data between different components or devices attached to the bus system. Additionally, the communications unit 1511 may include one or more devices used to transmit and receive data, such as a modem or a network adapter. Further, a memory may be, for example, the memory 1507 or a cache such as found in an interface and memory controller hub that may be present in the communications fabric 1503.

In addition, the computing device 1502 may be implemented in a network of data processing systems, the network being a medium used to provide communications links between various devices and computers connected together the network data processing system. The network may include various computing devices, as well as connections, such as wire, wireless communication links, or fiber optic cables.

In one example, the network is the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the network of data processing systems also may be implemented as a number of different types of networks, such as for example, an intranet, a local area network (LAN), or a wide area network (WAN). As the EASK utility serves as a single knowledgebase for all users to find functional and technical details about an implemented solution, companies may provide access to this knowledge through their intranet or they may choose to install the utility in a cloud mode in the Internet and provide access to users through this cloud mode over the Internet.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. A method in a data processing system for creating a design for an enterprise software solution, the method comprising:
receiving, from a user in an organization, information about business processes of the organization;
generating, from the information about the business processes, a list of functional requirements for the organization;
identifying, from an application knowledgebase, configuration settings that enable the functional requirements;
creating a project knowledgebase that captures the enterprise software solution design of the organization; and
storing the functional requirements and the configuration settings in the project knowledgebase.

2. The method of claim 1, wherein the application knowledgebase and the project knowledgebase comprise a structured format in which functional requirements and configuration settings for the organization are stored as individual objects with tags and links to other matching objects.

3. The method of claim 1, further comprising:
providing one or more reports of the functional requirements and the configuration settings for the enterprise software solution design being implemented for the organization to the user.

4. The method of claim 3, wherein a report comprises one of a detailed view of an individual selected functional requirement including linked objects and attributes, a detailed view of an individual selected configuration setting including linked objects and attributes, or a consolidated view of all the functional requirements and configuration settings including linked objects and attributes.

5. The method of claim 1, wherein the user selects the functional requirements and the configuration settings to be stored in the project knowledgebase.

6. The method of claim 1, wherein receiving information about business processes implemented by the organization further comprises:
providing an initial set of questions to the user; and
receiving responses to the initial set of questions from the user.

7. The method of claim 6, wherein the responses include information specifying business scenarios in which information in the responses are applicable.

8. The method of claim 6, further comprising:
responsive to receiving responses to the initial set of questions from the user, providing follow-up questions to the user based on the responses to the initial set of questions; and
receiving responses to the follow-up questions from the user.

9. The method of claim 1, wherein receiving information about business processes implemented by the organization further comprises:
receiving a set of search criteria from the user; and
responsive to providing a set of search results to the user, receiving a selection of the business process information from the set of search results by the user.

10. The method of claim 1, further comprising:
prior to generating the list of functional requirements, receiving content from a solution provider, wherein the content comprises all enterprise software solution data for a particular business process area; and
adding the content to a knowledgebase schema to form the application knowledgebase.

11. The method of claim 10, further comprising:
wherein the enterprise software solution data includes functional requirements, configuration settings, and relationship links between the functional requirements and configuration settings.

12. The method of claim 10, wherein receiving the content from the solution provider comprises one of receiving a file upload of the content or a manual update comprising the content.

13. A method in a data processing system for documenting a design of an enterprise software solution, the method comprising:
obtaining configuration settings for an implemented solution;
identifying, from an application knowledgebase, functional requirements that are matched to the configuration settings;
creating a project knowledgebase for documenting the enterprise software solution for the organization from the application knowledgebase; and
storing the configuration settings and the matching functional requirements in the project knowledgebase.

14. The method of claim 13, further comprising:
providing a report of the functional requirements and the configuration settings for the enterprise software solution design being documented for the organization to a user.

15. The method of claim 14, wherein the user selects the functional requirements and the configuration settings to be stored in the project knowledgebase.

16. A method in a data processing system for documenting a design of an enterprise software solution, the method comprising:
obtaining functional requirements for an implemented solution;
identifying, from an application knowledgebase, configuration settings that enable the functional requirements;
creating a project knowledgebase for documenting the enterprise software solution for the organization from the application knowledgebase; and
storing the functional requirements and the enabling configuration settings in the project knowledgebase.

17. The method of claim 16, further comprising:
providing a report of the functional requirements and the configuration settings for the enterprise software solution design being documented for the organization to a user.

18. The method of claim 17, wherein the user selects the functional requirements and the configuration settings to be stored in the project knowledgebase.

19. A method in a data processing system for determining points of impact for a change in an enterprise software solution, the method comprising:
receiving, from a user, a set of search criteria for one of a functional requirement or a configuration setting in an enterprise software;
providing, from a project knowledgebase, a list of functional requirements or configuration settings matching the set of search criteria to the user; and
responsive to receiving a selection by the user of a functional requirement or configuration setting in the list, providing, from the project knowledgebase, a list to the user of areas in the enterprise software impacted by a change to the selected functional requirement or configuration setting.

20. The method of claim 19, wherein providing a list to the user of the areas in the enterprise software impacted by a change to the selected functional requirement or configuration setting includes providing a list to the user of areas in the enterprise software where the selected requirement or configuration setting is used.

21. The method of claim 19, wherein the areas in the enterprise software impacted by a change to the selected functional requirement or configuration setting are areas comprising the selected functional requirement, the selected configuration setting, or other objects linked to the selected requirement or selected configuration setting.
